(19) United States
(12) Patent Application Publication
(10) Pub. No.: US 2022/0209949 A1
(43) Pub. Date: Jun. 30, 2022

(54) SECURE COMMUNICATION DEVICE AND SECURE COMMUNICATION PROGRAM

(71) Applicant: PSDL, Seongnam-si (KR)

(72) Inventors: Sungwoo Chun, Gimpo-si (KR); Deok Soo Hwang, Sejong-si (KR)

(21) Appl. No.: 17/459,886

(22) Filed: Aug. 27, 2021

(30) Foreign Application Priority Data
Dec. 30, 2020 (KR) 10-2020-0187579

(51) Int. Cl. H04L 9/14; H04L 9/08; H04W 76/14

(52) U.S. Cl. CPC H04L 9/14; H04L 9/0825; H04L 9/0891; H04L 2209/805; H04L 9/0869; H04W 76/14; H04L 9/0894

(57) ABSTRACT

Provided is a secure communication device. The secure communication device include: an audio input terminal; an antenna for receiving an RF signal; and a control unit that encrypts an audio signal inputted to the audio input terminal based on the RF signal received by the antenna, and transmits the encrypted audio signal to a paired receiver through the antenna.

### CROSS-REFERENCE TO RELATED APPLICATIONS

This application claims the priority of the Korean Patent Applications NO 10-2020-0187579 filed on Dec. 30, 2020, in the

Korean Intellectual Property Office, the disclosure of which is incorporated herein by reference.

### BACKGROUND OF THE INVENTION

### 1. Field of the invention

The present invention relates to a secure communication device and a secure communication program, and more specifically, to a secure communication device usable as a radio transceiver and a secure communication program.

### 2. Description of the Prior Art

Security may be very important not only in the military but also in communications between usual individuals. For example, since a radio transceiver as one of communication means is usually operated in the 1:N manner, all radio transceivers may simultaneously receive traffic.

In other words, conventionally, since there is no 1:1 communication operation concept in which a sender designates a predetermined radio transceiver to communicate therewith, any receivable radio transceiver can receive traffic regardless of the sender's intention.

Meanwhile, since the conventional radio transceiver has a security function configured by very simple algorithm, the security of all connected radio transceivers is lost when the above algorithm is exposed.

In other words, in the related art, a fixed security algorithm, for example, has been applied to the radio transceiver and used for security enhancement, and most of the equipment has been operated without any consideration for situations of theft or loss.

Accordingly, even when the radio transceiver has an embedded security algorithm, periodic or non-periodic updates are not conducted, so there is a definite limit to maintaining the security.

### SUMMARY OF THE INVENTION

The present invention provides a secure communication device usable as a radio transceiver and a secure communication program.

The present invention further provides a secure communication device having a strong security function and a secure communication program.

The technical problems to be solved by the present invention are not limited to the above description.

In order to solve the above technical problems, the present invention provides a secure communication device.

According to one embodiment, the secure communication device includes: an audio input terminal; an antenna for receiving an RF signal; and a control unit for encrypting an audio signal inputted to the audio input terminal based on the RF signal received by the antenna, and transmitting the encrypted audio signal to a paired receiver through the antenna.

According to one embodiment, the control unit may transmit the encrypted audio signal to one receiver or to a plurality of receivers.

According to one embodiment, the secure communication device may further include an audio output terminal, and when the antenna receives an RF signal from a paired sender, the control unit may decrypt the encrypted audio signal transmitted through the RF signal to output the decrypted audio signal through the audio output terminal.

According to the first embodiment, the secure communication device may further include a memory for storing the audio signal, wherein the memory further stores a receiver private encryption key (Priv_rr), the control unit includes: a random number generation unit for newly generating a random number based on the RF signal to encrypt the audio signal whenever the RF signal is received; an encryption key generation unit configured to generate a sender private encryption key (Priv_sr) by using the random number generated by the random number generation unit, and generate a sender public encryption key (Pub_sr) based on the sender private encryption key (Priv_sr), so as to generate a shared encryption key (S_Key) by using any one of the sender private encryption key (Priv_sr) and the sender public encryption key (Pub_sr) and the receiver private encryption key (Priv_rr); and an encryption unit for encrypting the audio signal stored in the memory by using the generated shared encryption key (S Key), and the control unit, when receiving the RF signal, may generate the random number through the random number generation unit, generate the sender private encryption key (Priv_sr), the sender public encryption key (Pub_sr) and the shared encryption key (S Key) through the encryption key generation unit, encrypt the audio signal using the shared encryption key (S Key) through the encryption unit, and transmit the encrypted audio signal (DataEnc) and the generated sender public encryption key (Pub_sr) to the receiver through the antenna. According to the first embodiment, the receiver may decrypt the encrypted audio signal (DataEnc) by using the receiver private encryption key (Priv_rr) and the transmitted sender public encryption key (Pub_sr).

According to the first embodiment, the receiver private encryption key (Priv_rr) may be provided to the sender during pairing.

According to the second embodiment, the secure communication device may further include a memory for storing the audio signal, wherein the memory further stores a master encryption key, the control unit includes: a random number generation unit for newly generating a random number based on the RF signal to encrypt the audio signal whenever the RF signal is received; an encryption key generation unit configured to generate a sender private encryption key (Priv sr) by using the random number generated by the random number generation unit, and generate a sender public encryption key

(Pub sr) based on the sender private encryption key (Priv_sr), so as to generate a shared encryption key (S Key) by using any one of the sender private encryption key (Priv_sr) and the sender public encryption key (Pub_sr) and the master encryption key; and an encryption unit for encrypting the audio signal stored in the memory by using the generated shared encryption key (S Key), and the control unit, when receiving the RF signal, may generate the random number through the random number generation unit, generate the sender private encryption key (Priv_sr), the sender public encryption key (Pub_sr) and the shared encryption key (S Key) through the encryption key generation unit, encrypt the audio signal using the shared encryption key (S Key) through the encryption unit, and transmit the encrypted audio signal (DataEnc) and the generated sender public encryption key (Pub_sr) to the receiver through the antenna.

According to the second embodiment, the master encryption key may be any one of a master private encryption key (Priv_m) and a master public encryption key (Pub_m).

According to the second embodiment, the receiver may decrypt the encrypted audio signal (DataEnc) by using the possessing master encryption key and the transmitted sender public encryption key (Pub_sr).

According to the second embodiment, the sender private encryption key (Priv_sr) may be refreshed using the newly generated random number, so that the shared encryption key (S Key) is continuously regenerated.

According to the second embodiment, the master encryption key may be provided to the receiver during pairing.

According to the third embodiment, the secure communication device may further include a memory for storing the audio signal, wherein the memory further stores a receiver public encryption key (Pub_rr), the control unit includes: a random number generation unit for newly generating a random number based on the RF signal to encrypt the audio signal whenever the RF signal is received; an encryption key generation unit configured to generate a sender private encryption key (Priv_sr) by using the random number generated by the random number generation unit, and generate a sender public encryption key (Pub_sr) based on the sender private encryption key (Priv_sr), so as to generate a shared encryption key (S Key) by using any one of the sender private encryption key (Priv_sr) and the sender public encryption key (Pub_sr) and the receiver public encryption key (Pub_rr); and an encryption unit for encrypting the audio signal stored in the memory by using the generated shared encryption key (S Key) the control unit, when receiving the RF signal, may generate the random number through the random number generation unit, generate the sender private encryption key (Priv_sr), the sender public encryption key (Pub_sr) and the shared encryption key (S Key) through the encryption key generation unit, encrypt the audio signal using the shared encryption key (S Key) through the encryption unit, and transmit the encrypted audio signal (DataEnc) and the generated sender public encryption key (Pub_sr) to the receiver through the antenna.

According to the third embodiment, the receiver may decrypt the encrypted audio signal (DataEnc) by using the receiver private encryption key (Priv_rr) and the transmitted sender public encryption key (Pub_sr).

According to the third embodiment, the receiver public encryption key (Pub_rr) may be provided to the sender during pairing.

According to the fourth embodiment, the secure communication device may further include a memory for storing the audio signal, wherein the control unit includes: a random number generation unit for newly generating a random number based on the RF signal to encrypt the audio signal whenever the RF signal is received; an encryption key generation unit for generating an encryption key by using the random number generated by the random number generation unit; and an encryption unit for encrypting the audio signal stored in the memory by using the generated encryption key, and the control unit, when receiving the RF signal, may generate the random number through the random number generation unit, generate the encryption key through the encryption key generation unit, encrypt the audio signal through the encryption unit, and transmit the encrypted audio signal and the generated encryption key to the receiver through the antenna.

According to the embodiments, the encryption unit may further encrypt a MASK of an ID assigned to the receiver, and the control unit may further transmit the encrypted ID MASK (ID_MASKEnc) to the receiver through the antenna, in which an audio data packet composed of a payload including the generated sender public encryption key (Pub_sr), the encrypted ID MASK (ID_MASKEnc), and the encrypted audio signal (DataEnc) may be transmitted to the receiver.

According to the embodiments, when the paired receiver is provided with a plurality of receivers, and a plurality of groups including at least one among the receivers are set, the control unit may add a preamble, in which the corresponding group ID included in the payload is encrypted, so as to transmit an audio data packet including the payload added to the preamble to the receivers.

According to the second embodiment, the preamble may be distributed to each of the receivers during pairing, and the encryption unit may encrypt the group ID by using the sender public encryption key (Pub_sr).

Meanwhile, the present invention provides a secure communication program.

According to one embodiment, the secure communication program may be stored in a medium to execute: a login step of executing a login module to enable a user having downloaded and installed a dedicated app provided from a server to log in; a pairing step of executing a pairing module to enable the user to pair the secure communication device according to claim 1 with at least one receiver; and an audio communication step of executing an audio communication module to enable the user to communicate with the paired at least one receiver by using an audio signal.

The secure communication device according to one embodiment of the present invention includes: a memory for storing data to be transmitted to an external electronic device and a fixed master key;

an antenna for communicating with the external electronic device; and a control unit configured to generate a refresh key based on the RF signal received by the antenna, and encrypt the data stored in the memory based on the refresh key and the fixed key, so as to transmit the encrypted data and the refresh key to the external electronic device through the antenna. The master key may already be shared with at least one external electronic device before the transmission.

According to the embodiment of the present invention, the secure communication device may include: an audio input terminal; an antenna for receiving an RF signal; and a control unit for encrypting an audio signal inputted to the audio input terminal based on the RF signal received by the antenna, and transmitting the encrypted audio signal to a paired receiver through the antenna.

Accordingly, the secure communication device usable as a radio transceiver and the secure communication program enabling the same can be provided.

According to the embodiment of the present invention, the secure communication device capable of one-to-one audio communication and multilateral audio communication and the secure communication program enabling the same can be provided.

In addition, according to the embodiment of the present invention, the secure communication device for minimizing communication interference through a frequency hopping scheme can be provided.

In addition, according to the embodiment of the present invention, audio signals transmitted and received between secure communication devices are encrypted through any one of symmetric key algorithm and asymmetric key algorithm, so that a secure communication device having a strong security maintenance function can be provided.

### BRIEF DESCRIPTION OF THE DRAWINGS

The above and other objects, features, and advantages of the present invention will be more apparent from the following detailed description taken in conjunction with the accompanying drawings, in which:

FIG. 1 is a conceptual diagram for explaining a secure communication device functioning as a radio transceiver according to the embodiment of the present invention.

FIG. 2 is a conceptual diagram for explaining a secure communication device capable of multilateral communication according to the embodiment of the present invention.

FIG. 3 is a conceptual diagram for explaining a secure communication device capable of maintaining security by group according to the embodiment of the present invention.

FIG. 4 is a block diagram schematically showing a secure communication device according to the first embodiment of the present invention.

FIG. 5 is a block diagram for explaining a process in which an input audio signal is transmitted to a receiver in the secure communication device according to the first embodiment of the present invention.

FIG. 6 is a block diagram for explaining a process in which an audio signal received from a sender is outputted in the secure communication device according to the first embodiment of the present invention.

FIG. 7 is a block diagram showing the secure communication device.

FIG. 8 is a flowchart for explaining a pairing process between secure communication devices according to the first embodiment of the present invention.

FIG. 9 is a flowchart for time-sequentially explaining an encryption process of a control unit for the inputted audio signal in the secure communication device according to the first embodiment of the present invention.

FIG. 10 is a flowchart for time-sequentially explaining a decryption process of the receiver for the encrypted audio signal in the secure communication device according to the first embodiment of the present invention.

FIG. 11 is a flowchart for explaining a pairing process between secure communication devices according to a second embodiment of the present invention.

FIG. 12 is a flowchart for time-sequentially explaining an encryption process of a control unit for the inputted audio signal in the secure communication device according to the second embodiment of the present invention.

FIG. 13 is a flowchart for time-sequentially explaining a decryption process of the receiver for the encrypted audio signal in the secure communication device according to the second embodiment of the present invention.

FIG. 14 is a flowchart for explaining a pairing process between secure communication devices according to a third embodiment of the present invention.

FIG. 15 is a flowchart for time-sequentially explaining an encryption process of a control unit for the inputted audio signal in the secure communication device according to the third embodiment of the present invention.

FIG. 16 is a flowchart for time-sequentially explaining a decryption process of the receiver for the encrypted audio signal in the secure communication device according to the third embodiment of the present invention.

FIG. 17 is a flowchart for explaining a pairing process between secure communication devices according to a fourth embodiment of the present invention.

FIG. 18 is a flowchart for time-sequentially explaining an encryption process of a control unit for the inputted audio signal in the secure communication device according to the fourth embodiment of the present invention.

FIG. 19 is a flowchart for time-sequentially explaining a decryption process of the receiver for the encrypted audio signal in the secure communication device according to the fourth embodiment of the present invention.

FIG. 20 is a schematic diagram showing an audio data packet transmitted to the receiver according to the embodiment of the present invention.

FIG. 21 is a schematic diagram showing an audio data packet transmitted to a plurality of grouped receivers according to the embodiment of the present invention.

FIG. 22 is a block diagram schematically showing a secure communication device according to the fifth embodiment of the present invention.

FIG. 23 is a block diagram for explaining a process in which an input audio signal is transmitted to a receiver in the secure communication device according to the fifth embodiment of the present invention.

FIG. 24 is a block diagram for explaining a process in which an audio signal received from a sender is outputted in the secure communication device according to the fifth embodiment of the present invention.

FIG. 25 is a flowchart for time-sequentially explaining an encryption process of a control unit for the inputted audio signal in the secure communication device according to the fifth embodiment of the present invention.

FIG. 26 is a flowchart for time-sequentially explaining a decryption process of the control unit for the encrypted and transmitted audio signal in the secure communication device according to the fifth embodiment of the present invention.

FIG. 27 is a flowchart sequentially showing steps in which a secure communication program is executed according to the embodiment of the present invention.

### DETAILED DESCRIPTION OF THE EXEMPLARY EMBODIMENTS

The inventive concepts will now be described more fully hereinafter with reference to the accompanying drawings, in which exemplary embodiments of the inventive concepts are shown. It should be noted, however, that the inventive concepts are not limited to the following exemplary embodiments, and may be implemented in various forms. Accordingly, the exemplary embodiments are provided only to disclose the inventive concepts and let those skilled in the art know the category of the inventive concepts.

It will be understood that when an element such as a layer, region or substrate is referred to as being “on” another element, it can be directly on the other element or intervening elements may be present. In addition, in the drawings, the thicknesses of layers and regions are exaggerated for clarity.

It will be also understood that although the terms first, second, third etc. may be used herein to describe various elements, these elements should not be limited by these terms. These terms are only used to distinguish one element from another element. Thus, a first element in some embodiments could be termed a second element in other embodiments without departing from the teachings of the present invention. Exemplary embodiments of aspects of the present inventive concepts explained and illustrated herein include their complementary counterparts. As used herein, the term “and/or” includes any and all combinations of one or more of the associated listed items.

The terminology used herein is for the purpose of describing particular embodiments only and is not intended to limit the invention. As used herein, the singular terms “a”, “an” and “the” are intended to include the plural forms as well, unless the context clearly indicates otherwise. It will be further understood that the terms “comprises”, “comprising”, “includes”, “including”, “have”, “has” and/or “having” when used herein, specify the presence of stated features, integers, steps, operations, elements, and/or components, but do not preclude the presence or addition of one or more other features, integers, steps, operations, elements, components, and/or groups thereof. Furthermore, it will be understood that when an element is referred to as being “connected” or “coupled” to another element, it may be directly connected or coupled to the other element or intervening elements may be present.

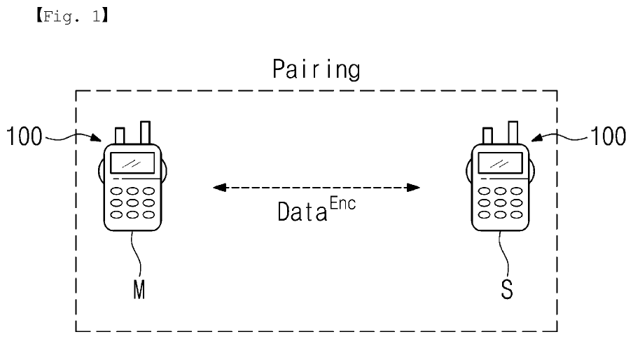

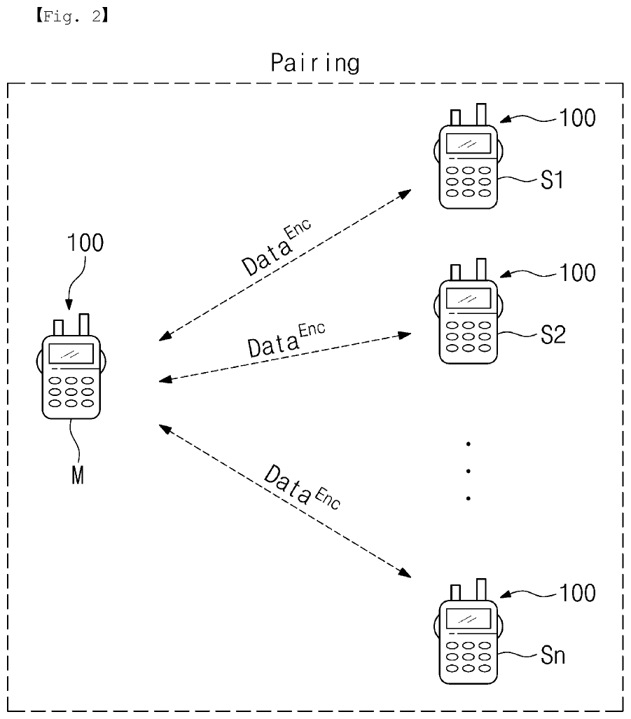

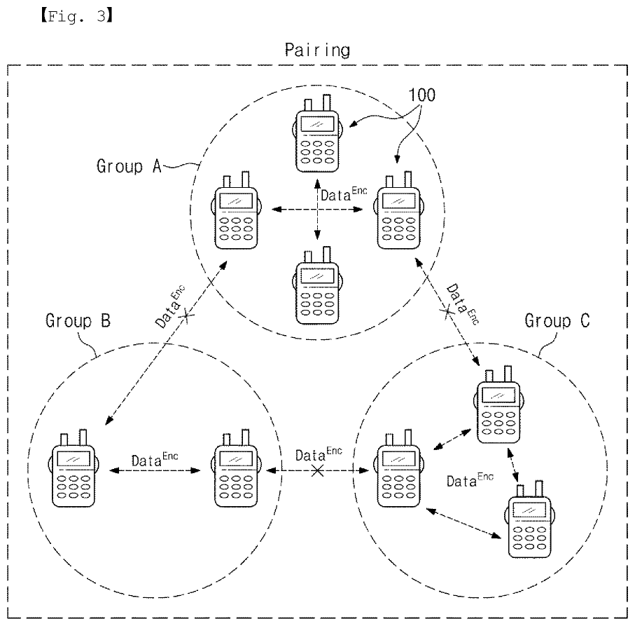

FIG. 1 is a conceptual diagram for explaining the secure communication device functioning as a radio transceiver according to the embodiment of the present invention. FIG. 2 is a conceptual diagram for explaining the secure communication device capable of multilateral communication according to the embodiment of the present invention. FIG. 3 is a conceptual diagram for explaining a secure communication device capable of maintaining security by group according to the embodiment of the present invention.

As shown in FIG. 1, secure communication devices 100 according to the embodiment of the present invention may be paired with each other through analog communication or digital communication such as Bluetooth Low Energy and CDMA to transmit and receive audio signals.

In other words, according to the embodiment of the present invention the secure communication device 100 may function as a radio transceiver, for example. In the case of one-to-one audio communication, when any one of two secure communication devices 100 is designated as a master (M), the other one serves as a slave (S).

In addition, based on the direction of transmitting the audio signal, one of the two secure communication devices 100 may function as a sender for transmitting the audio signal, and the other one may function as a receiver for receiving the audio signal. In the case of one-to-one audio communication, the sensor and the receiver may be interoperable to each other whenever required by users

Meanwhile, the secure communication device 100 according to the embodiment of the present invention may encrypt the audio signal and transmit the encrypted audio signal DataEnc. In addition, the secure communication device 100 according to one embodiment of the present invention may decrypt the encrypted and received audio signal DataEnc. Accordingly, strong security may be maintained between audio communications. The above encryption and decryption for audio signals will be described in more detail below.

Referring to FIG. 2, in the embodiment of the present invention, the secure communication device 100 designated as the master M may be paired with a plurality of slaves S1, S2, . . . , and Sn, so as to transmit the encrypted audio signal DataEnc to the slaves S1, S2, . . . , and Sn, or receive the encrypted audio signal DataEnc from the slaves.

Thus, according to one embodiment of the present invention, the secure communication device 100 capable of one-to-one audio communication as well as multilateral audio communication may be provided.

Referring to FIG. 3, a plurality of pairing-connected secure communication devices 100 may form a plurality of communication groups, and one-to-one or multilateral audio communication may be conducted within the corresponding communication group. For example, some of the paired secure communication devices 100 may belong to communication group A to perform multilateral audio communication within the communication group A, another secure communication devices may belong to communication group B to perform one-to-one or multilateral audio communication within the communication group B, and the others may belong to communication group C to perform multilateral audio communication within the communication group C.

Transmission and reception of encrypted audio signals DataEnc may be restricted between secure communication devices 100 belonging to communication groups different from each other, respectively, and accordingly, security between the communication groups may also be maintained. The size and number of each communication group may be arbitrarily set during pairing, and modified at any time as needed.

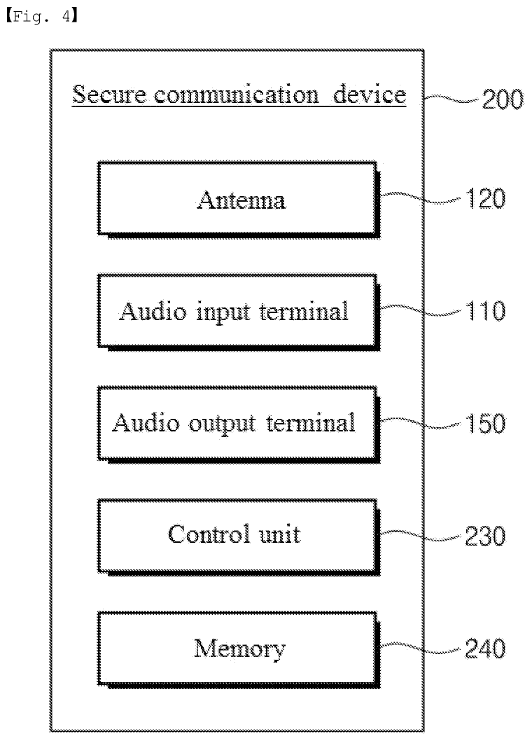

Hereinafter, the secure communication device according to the first embodiment of the present invention will be described with reference to FIGS. 4 to 7.

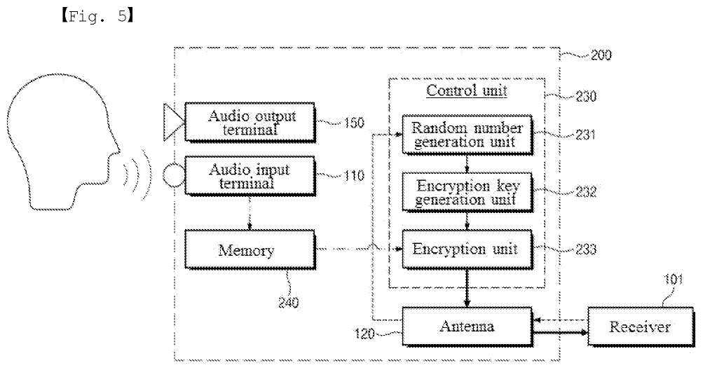

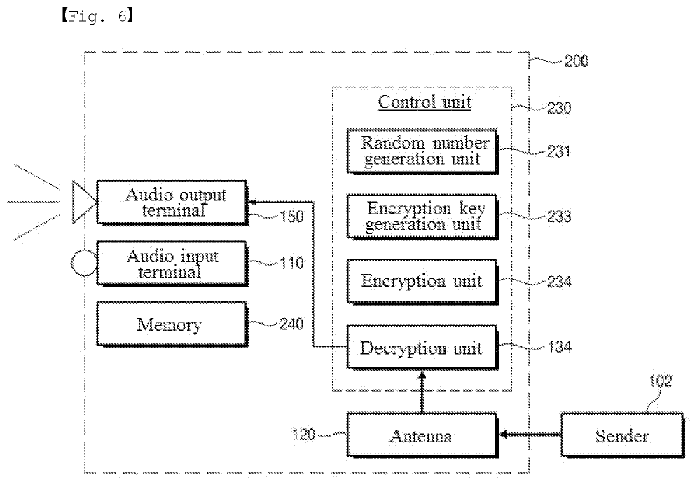

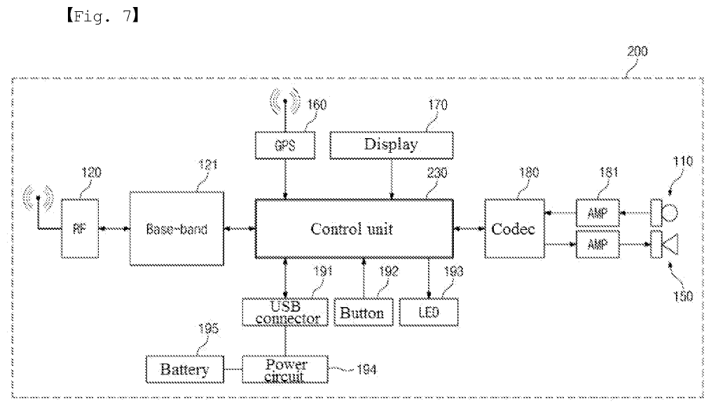

FIG. 4 is a block diagram schematically showing a secure communication device according to the first embodiment of the present invention. FIG. 5 is a block diagram for explaining a process in which an input audio signal is transmitted to a receiver in the secure communication device according to the first embodiment of the present invention. FIG. 6 is a block diagram for explaining a process in which an audio signal received from a sender is outputted in the secure communication device according to the first embodiment of the present invention. FIG. 7 is a block diagram showing the secure communication device according to the first embodiment of the present invention.

Referring to FIG. 4, the secure communication device 200 according to the first embodiment of the present invention, which audio-communicates while transmitting and receiving an encrypted audio signal DataEnc between paired and connected two parties or multilateral parties, may include an audio input terminal 110, an antenna 120, a control unit 230, a memory 240, and an audio output terminal 150.

The audio input terminal 110, which serves as a device to which a user's audio signal is inputted, may be provided as, for example, a microphone. Correspondingly, the secure communication device 200 according to the first embodiment of the present invention may further include an audio output terminal 150. The audio output terminal 150, which serves as a device for outputting an audio signal received from another secure communication device 200, may be provided as, for example, a speaker.

The antenna 120 may receive an RF signal. The RF signal corresponds to a broad concept including electromagnetic waves applied from the outside, and may be understood as a concept including any one or both signals of a signal that includes information and a signal that does not include information. The antenna 120 may receive the RF signal from a paired sender.

In addition, the antenna 120 may receive RF signals generated from the paired slaves S1, S2, . . . , and Sn.

In other words, the antenna 120 may also receive RF signals generated between the slaves S1, S2, . . . , and Sn and corresponding to noise, in addition to the RF signal transmitted from a specific sender.

Meanwhile, when functioning as a sender, the antenna 120 may transmit the encrypted audio signal DataEnc generated by the control unit 230 to one or a plurality of slaves S1, S2, . . . , and Sn forming the same communication group serving as a receiver.

The memory 240 may store an audio signal. Specifically, the memory 240 may store an audio signal of the user inputted through the audio input terminal 110. Accordingly, the audio signal stored in the memory 240 may be encrypted by the control unit 230.

The memory 240 according to the first embodiment of the present invention may further store the receiver private encryption key Priv_rr. The receiver private encryption key Priv_rr may be provided from the receiver 101 of FIG. 5 during pairing and stored in the memory 240.

The receiver private encryption key Priv_rr may be used to generate a shared encryption key S Key in the control unit 230, and will be described in more detail below.

The control unit 230 may encrypt the audio signal inputted to the audio input terminal 110 based on the RF signal received by the antenna 120.

The control unit 230 having encrypted the audio signal may transmit the encrypted audio signal DataEnc to the paired one or multiple receivers 101 of FIG. 5 through the antenna 120.

In order to eliminate crosstalk with other receivers 101 in FIG. 5 having no approval for audio communication, the control unit 230 may distribute the frequency to a receiver 101 in FIG. 5 approved for the audio communication through frequency hopping, and transmit an encrypted audio signal DataEnc to the receiver 101 of FIG. 5 by using the corresponding frequency band.

In addition, when the antenna 120 receives the RF signal from the paired sender 102 in FIG. 6, the control unit 230 may decrypt the encrypted audio signal DataEnc transmitted through the RF signal, and output a decrypted audio signal through the audio output terminal 150.

Referring to FIG. 5, the control unit 230 according to the first embodiment of the present invention may include a random number generation unit 231, an encryption key generation unit 232, and an encryption unit 233.

The random number generation unit 231 may generate a random number based on the RF signal received by the antenna 120. The random number generation unit 231 may generate a new random number based on the RF signal in order to encrypt the audio signal, whenever the RF signal is received by the antenna 120. The random number generation unit 231 may generate a random number by using disordered fluctuations in the intensity or sensitivity of the RF signal received in real time by the antenna 120.

The random number generation unit 231 may generate a random number based on an RF signal received from a specific receiver 101 among RF signals received by the antenna 120.

In addition, even when an RF signal corresponding to noise is received in viewpoint of the antenna 120, the random number generation unit 231 may generate a random number based on the RF signal.

Further, the random number generation unit 231 may generate a random number based on the audio signal inputted to the audio input terminal 110.

According to the first embodiment of the present invention, even the RF signal corresponding to the noise to the antenna 120 and the inputted audio signal may be used by the random number generation unit 231 for generating the random number, so that the amount of random number generation and the speed of random number generation may be improved.

Accordingly, the random number generation unit 231 according to the first embodiment of the present invention may generate a physical random number based on an RF signal including an ambient signal and a magnetic signal and an audio signal to be transmitted, or on the contrary, may generate a random number by using an algorithmic manner. In addition, the random number generation unit 231 may also generate a random number by using a circuit manner such as a ring oscillator.

Hereinafter, it is assumed that the random number generation unit 231 generates a physical random number based on an RF signal.

The encryption key generation unit 232 may generate a sender private encryption key Priv_sr by using the random number generated by the random number generation unit 231.

In addition, the encryption key generation unit 232 may generate a sender public encryption key Pub_sr based on the sender private encryption key Priv_sr. The encryption key generation unit 232 may generate a sender public encryption key Pub_sr based on the sender private encryption key Priv_sr, by using a mathematical scheme, for example, an elliptic curve constant G.

In addition, the encryption key generation unit 232 may generate a shared encryption key S Key, based on the random number generated by the random number generation unit 231. For example, the encryption key generation unit 232 may generate a shared encryption key S Key by using the sender public encryption key Pub_sr and the receiver private encryption key Priv_rr provided from the receiver 101 during pairing.

Since the shared encryption key S Key is generated based on the random number, improved security intensity can be provided.

The encryption unit 233 may encrypt the audio signal stored in the memory 240 by using the shared encryption key S Key generated by the encryption key generation unit 232. The encryption unit 233 according to the first embodiment of the present invention may further encrypt a MASK of an ID assigned to the receiver 101. In addition, the encryption unit 233 may be further encrypt an ID of a group to which each secure communication device 200 belongs.

As described above, the random number generation unit 231 may newly generate a random number whenever an RF signal is received. Accordingly, the encryption key generation unit 232 may continuously regenerate the sender private encryption key Priv_sr, the sender public encryption key Pub_sr, and the shared encryption key S Key, so that the shared encryption key S Key may be refreshed whenever the RF signal is received.

Referring to FIG. 6, the control unit 230 may further include a decryption unit 234.

The decryption unit 234 may receive the encrypted audio signal DataEnc transmitted through the signal from the antenna 120 receiving the RF signal from the paired sender 102, and decrypt the received audio signal.

Accordingly, the audio signal decrypted by the decryption unit 234 may be outputted to the outside by the audio output terminal 150 provided as a speaker.

Meanwhile, referring to FIG. 7, the secure communication device 200 according to the first embodiment of the present invention may further include a base-band processing unit 121 connected between the antenna 120 and the control unit 230. In addition, the secure communication device 200 according to the first embodiment of the present invention may be provided with a location recognition module 160 such as GPS, and may be provided with a display unit 170 at an outer side thereof to display an operation state.

In addition, the secure communication device 200 according to the first embodiment of the present invention may be further provided with a codec 180 for converting an analog signal into a digital signal and an amplifier AMP 181 for increasing the amplitude of the input audio signal, in which the codec and the amplifier are connected between the control unit 230 and the audio input terminal 110 and the audio output terminal 150.

In addition, the secure communication device 200 according to the first embodiment of the present invention may further include a button 192 manipulated by the user and an LED lamp 193 for indicating a pairing connection status and the like, and may further include a battery 195 and a power circuit 194 for supplying power from the battery 195 to the control unit 230. The control unit 230 and the power circuit 194 may be provided with a USB connector 191 connected therebetween.

Since the above additional components perform normal functions, detailed descriptions thereof will be omitted.

In the present specification, the public encryption key may correspond to an encryption key derived from a processing based on a private encryption key. The public encryption key may be generated through the private encryption key, however, there may be a relationship in which the private encryption key cannot be generated through the public encryption key. In other words, the relationship between the private encryption key and the public encryption key may be defined as a one-way relationship only the public encryption key is enabled from the private encryption key.

In the present specification, the shared encryption key may be generated by a combination of encryption keys of the sender and the receiver. For example, the shared encryption key may be generated by a combination of a private encryption key or a shared encryption key of the sender and a private encryption key or a shared encryption key of the receiver. The shared encryption key of the sending side may be generated using a private encryption key of the sender or receiver and a public encryption key of the sender or receiver, and the shared encryption key of the receiving side may be generated using a private encryption key and a public encryption key that are not used by the sender side. For example, when the shared encryption key of the sender side is composed of the sender's private encryption key and the receiver's public encryption key, the shared encryption key of the receiving side may be composed of the sender's public encryption key and the receiver's private encryption key. In other words, the shared encryption keys of the sending side and the receiving side are generated with different private and public encryption keys, and accordingly, the encryption/decryption may be performed in a so-called asymmetric scheme. Accordingly, further enhanced security may be provided.

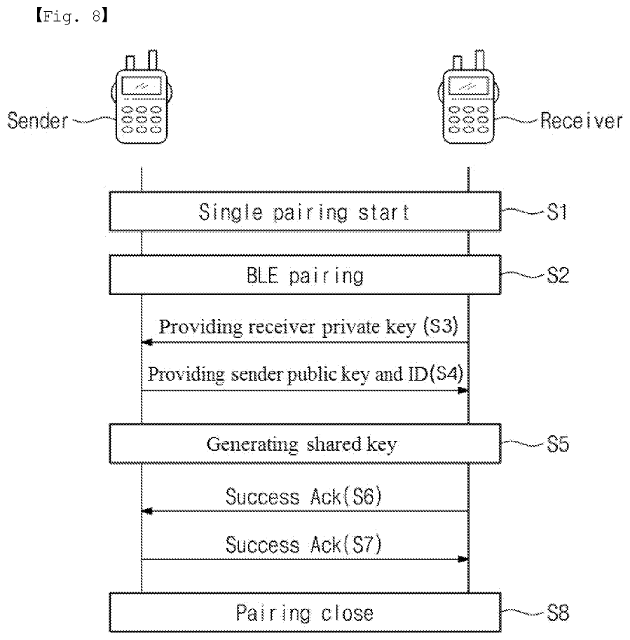

Hereinafter, a method of setting a pairing between secure communication devices according to the first embodiment of the present invention will be described with reference to FIG. 8.

Referring to FIG. 8, first, in a preliminary step to use the secure communication device as a radio transceiver, a pairing may start between the sender and at least one of the receivers (S1). To this end, Bluetooth Low Energy modules, for example, mounted in each of the sender and the receiver may be activated. Accordingly, the sender and the receiver may be paired through Bluetooth communication (S2).

During pairing, the receiver may provide the receiver private key to the sender (S3). The receiver may encrypt the receiver private key by using the receiver public key and provide the encrypted receiver private key to the sender. Accordingly, the receiver private key and the receiver public key may be provided to the sender.

When trying to communicate with a specific receiver, the sender may provide a sender public key and an ID of the specific receiver to the receiver (S4). For example, the sender may add an ID_Mask Header assigned to the specific receiver and transmit the added ID_Mask Header to a data payload transmitted to the receiver. The sender may use the previously provided receiver public key, and encrypt and transmit the sender public key and the ID.

Accordingly, a plurality of receivers may check the ID first, and ignore the ID when the transmitted audio data packet is not configured to be transmitted to themselves.

Thereafter, the sender and the receiver may use the receiver private key and the sender public key to generate a shared key and use the generated shared key as an encryption key (S5).

Thereafter, when a feedback signal (Success ack) for transmission success is received from the receiver (S6), the sender may transmit a response signal (Success ack) to the receiver (S7).

After step S7 is completed, the sender and the specific receiver may maintain the pairing connection to enable audio communication (S8).

The specific receiver may be one receiver or a plurality of receivers forming the communication group with the sender.

When the sender is paired with one receiver, a whisper communication mode, that is, one-to-one audio communication, may be conducted.

In addition, when the sender is paired with multiple receivers, a group communication mode, that is, multilateral audio communication may be conducted.

In the group communication mode, when the sender is designated as a master, the master, for audio communication between the remaining slaves, may share the private keys provided from a plurality of slave with each of the slaves.

In addition, when the sender is designated as a master in the group communication mode, the remaining slaves may use the master as a communication repeater to exchange audio signals with each other via the master.

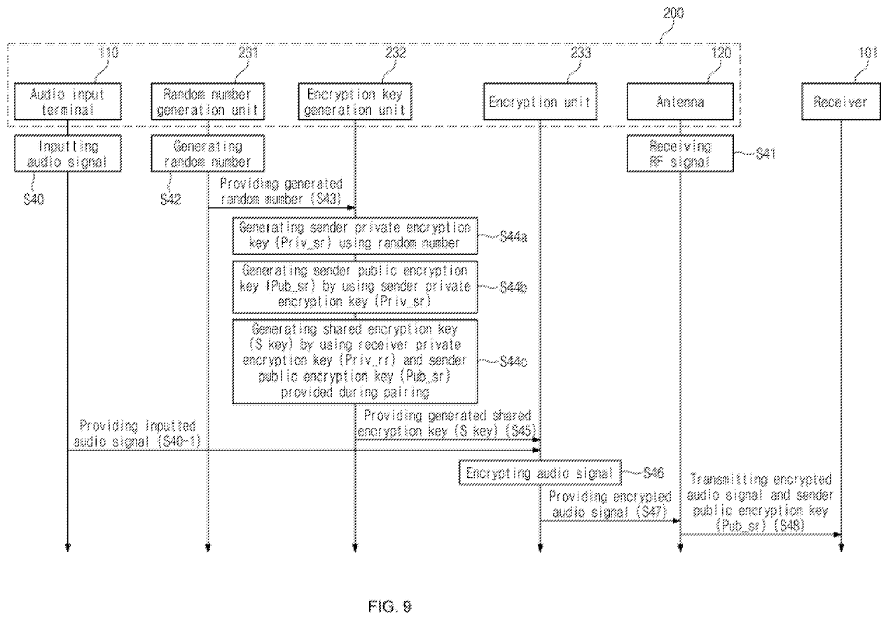

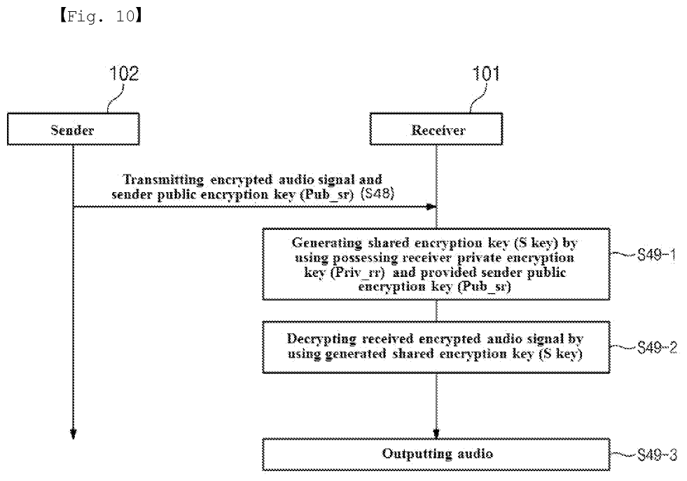

Hereinafter, a process of mutual audio communication between a plurality of secure communication devices in a paired state according to the first embodiment of the present invention will be described time-sequentially with reference to FIGS. 9 and 10.

Referring to FIG. 9, when an RF signal is received by the antenna 120 (S41), the secure communication device 200 may generate a new random number based on the RF signal, through the random number generation unit 231 whenever the RF signal is received (S42), and provide the generated random number to the encryption key generation unit 232 (S43).

Even when an audio signal is inputted to the audio input terminal 110 (S40), the secure communication device 200 may generate a new random number based on the audio signal, through the random number generation unit 231 whenever the audio signal is received (S42), and provide the generated random number to the encryption key generation unit 232 (S43).

Thereafter, the secure communication device 200 may generate a sender private encryption key Priv_sr by using the random number, through the encryption key generation unit 232 (S44a).

In addition, the secure communication device 200 may generate a sender public encryption key Pub_sr by using the sender private encryption key Priv_sr, through the encryption key generation unit 232 (S44b).

Thereafter, the secure communication device 200 may generate a shared encryption key S Key by using the receiver private encryption key Priv_rr provided from the receiver 101 during pairing and the generated sender public encryption key Pub_sr, through the encryption key generation unit 232 (S44c).

As described above, since the random number is used as a seed signal of the shared encryption key S Key, a new random number is generated whenever the RF signal is received, and accordingly, the shared encryption key S Key may be refreshed.

Thereafter, the secure communication device 200 may provide the shared encryption key S Key generated through the encryption key generation unit 232 to the encryption unit 233 (S45).

Thereafter, the secure communication device 200 may provide the audio signal inputted to the audio input terminal 110 to the encryption unit 233 (S40-1), encrypt the audio signal by using the shared encryption key S Key through the encryption unit 233 (S46), and provide the encrypted audio signal DataEnc to the antenna 120 (S47).

Thereafter, the secure communication device 200 may transmit the encrypted audio signal DataEnc and the sender public encryption key Pub_sr to the receiver 101 through the antenna 120 (S48).

Next, referring to FIG. 10, the receiver 101 having received the encrypted audio signal DataEnc and the sender public encryption key Pub_sr from the sender 102 through the RF signal may generate a shared encryption key S Key by using the possessing receiver private encryption key Priv_rr and the sender public encryption key Pub_sr provided from the sender 102 (S49-1).

Thereafter, the receiver 101 may decrypt the encrypted audio signal DataEnc provided from the sender 102 by using the generated shared encryption key S Key (S49-2).

Thereafter, the receiver 101 may output a decrypted audio signal through the audio output terminal 150 (S49-3).

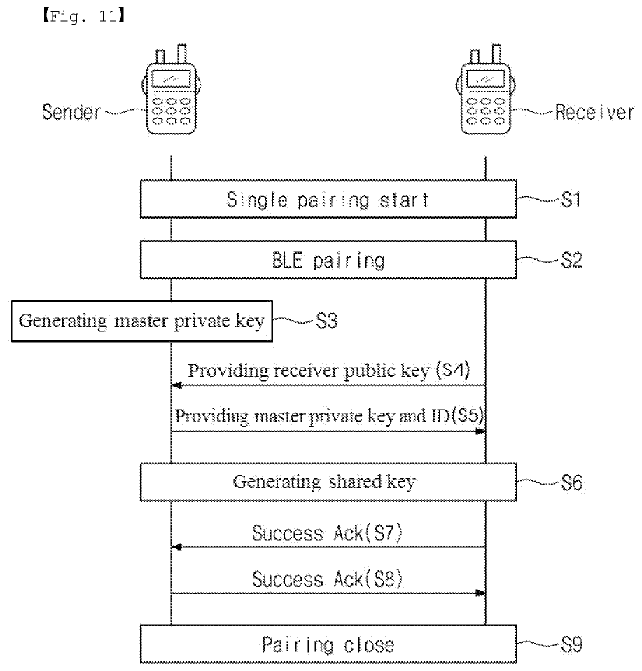

Hereinafter, a method of setting a pairing between secure communication devices according to the second embodiment of the present invention will be described with reference to FIG. 11.

The second embodiment of the present invention has a difference only in the pairing setting method and the encrypting scheme and has the same components compared with the first embodiment of the present invention, so detailed descriptions of the same components will be omitted.

Referring to FIG. 11, first, in a preliminary step to use the secure communication device as a radio transceiver, a pairing may start between the sender and at least one of the receivers (S1). To this end, Bluetooth Low Energy modules, for example, mounted in each of the sender and the receiver may be activated. Accordingly, the sender and the receiver may be paired through Bluetooth communication (S2).

During pairing, the sender may generate a master private key (S3).

The receiver may provide the receiver public key to the sender (S4).

When trying to communicate with a specific receiver, the sender may provide the generated master private key, a sender public key, and an ID of a specific receiver to the receiver (S5). For example, the sender may add an ID_Mask Header assigned to the specific receiver and transmit the added ID_Mask Header to a data payload transmitted to the receiver. The sender may use the previously provided receiver public key, and encrypt and transmit the master private key and the ID.

Accordingly, a plurality of receivers may check the ID first, and ignore the ID when the transmitted audio data packet is not configured to be transmitted to themselves.

Thereafter, the sender and the receiver may use the master private key and the sender public key to generate a shared key and use the generated shared key as an encryption key (S6).

Thereafter, when a feedback signal (Success ack) for transmission success is received from the receiver (S7), the sender may transmit a response signal (Success ack) to the receiver (S8).

After step S8 is completed, the sender and the specific receiver may maintain the pairing connection to enable audio communication (S9).

The specific receiver may be one receiver or a plurality of receivers forming the communication group with the sender.

When the sender is paired with one receiver, a whisper communication mode, that is, one-to-one audio communication, may be conducted.

In addition, when the sender is paired with multiple receivers, a group communication mode, that is, multilateral audio communication may be conducted.

As in the first embodiment, when the sender is designated as a master in the group communication mode, the master, for audio communication between the remaining slaves, may share the private keys provided from a plurality of slave with each of the slaves.

In addition, when the sender is designated as a master in the group communication mode, the remaining slaves may use the master as a communication repeater to exchange audio signals with each other via the master.

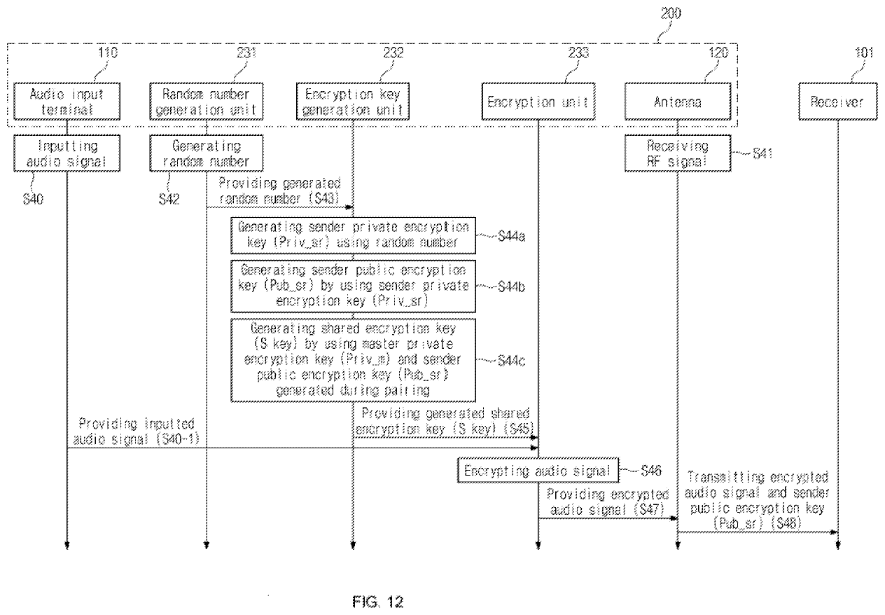

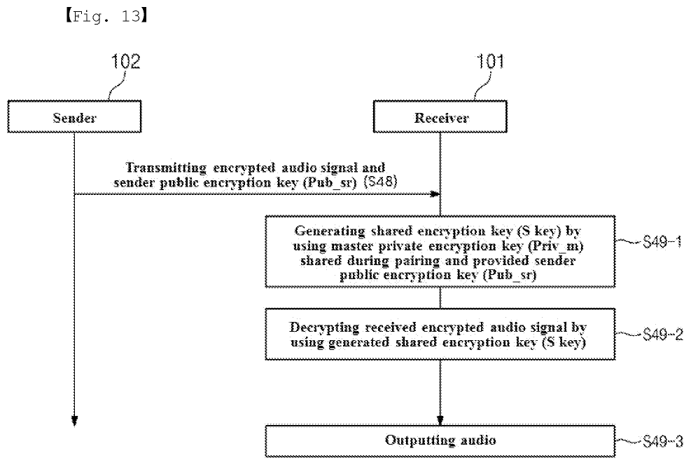

Hereinafter, a process of mutual audio communication between a plurality of secure communication devices in a paired state according to a second embodiment of the present invention will be described time-sequentially with reference to FIGS. 12 and 13.

Referring to FIG. 12, when an RF signal is received by the antenna 120 (S41), the secure communication device 200 may generate a new random number based on the RF signal, through the random number generation unit 231 whenever the RF signal is received (S42), and may provide the generated random number to the encryption key generation unit 232 (S43).

Even when an audio signal is inputted to the audio input terminal 110 (S40), the secure communication device 200 may generate a new random number based on the audio signal, through the random number generation unit 231 whenever the audio signal is received (S42), and may provide the generated random number to the encryption key generation unit 232 (S43).

Thereafter, the secure communication device 200 may generate a sender private encryption key Priv_sr by using the random number, through the encryption key generation unit 232 (S44a).

In addition, the secure communication device 200 may generate a sender public encryption key Pub_sr by using the sender private encryption key Priv_sr, through the encryption key generation unit 232 (S44b).

Thereafter, the secure communication device 200 may generate a shared encryption key S Key by using the master private encryption key Priv_m generated during pairing and the generated sender public encryption key Pub_sr, through the encryption key generation unit 232 (S44c).

As described above, since the random number is used as a seed signal of the shared encryption key S Key, a new random number is generated whenever the RF signal is received, and accordingly, the shared encryption key S Key may be refreshed.

Thereafter, the secure communication device 200 may provide the shared encryption key S Key generated through the encryption key generation unit 232 to the encryption unit 233 (S45).

Thereafter, the secure communication device 200 may provide the audio signal inputted to the audio input terminal 110 to the encryption unit 233 (S40-1), encrypt the audio signal by using the shared encryption key S Key through the encryption unit 233 (S46), and provide the encrypted audio signal DataEnc to the antenna 120 (S47).

Thereafter, the secure communication device 200 may transmit the encrypted audio signal DataEnc and the sender public encryption key Pub_sr to the receiver 101 through the antenna 120 (S48).

Continuously, referring to FIG. 13, the receiver 101 having received the encrypted audio signal DataEnc and the sender public encryption key Pub_sr from the sender 102 through the RF signal may generate a shared encryption key S Key by using the master private encryption key Priv_m shared during pairing and the sender public encryption key Pub_sr provided from the sender 102 (S49-1).

Thereafter, the receiver 101 may decrypt the encrypted audio signal DataEnc provided from the sender 102 by using the generated shared encryption key S Key (S49-2).

Thereafter, the receiver 101 may output a decrypted audio signal through the audio output terminal 150 (S49-3).

Meanwhile, as a modification, the receiver 101 may decrypt and output the received encrypted audio signal DataEnc by using only the shared master private encryption key Priv_m.

In addition, as another modification, a master public encryption key Pub_m may be generated upon pairing between the secure communication devices 200 and shared by each of the secure communication devices 200.

Accordingly, when the RF signal is received by the antenna 120, the secure communication device 200 may generate a new random number based on the RF signal, through the random number generation unit 231 whenever the RF signal is received, and provide the generated random number to the encryption key generation unit 232.

Thereafter, the secure communication device 200 may generate a sender private encryption key Priv_sr by using the random number, through the encryption key generation unit 232.

In addition, the secure communication device 200 may generate a sender public encryption key Pub_sr by using the sender private encryption key Priv_sr, through the encryption key generation unit 232.

Thereafter, the secure communication device 200 may generate a shared encryption key S Key by using the master public encryption key Pub_m generated during pairing and the generated sender public encryption key Pub_sr, through the encryption key generation unit 232.

As described above, since the random number is used as a seed signal of the shared encryption key S Key, a new random number is generated whenever the RF signal is received, and accordingly, the shared encryption key S Key may be refreshed.

Thereafter, the secure communication device 200 may provide the shared encryption key S Key generated through the encryption key generation unit 232 to the encryption unit 233.

In the above process, when an audio signal is inputted to the audio input terminal 110, the secure communication device 200 may provide the inputted audio signal to the encryption unit 233.

Thereafter, the secure communication device 200 may provide the audio signal inputted to the audio input terminal 110 to the encryption unit 233, encrypt the audio signal by using the shared encryption key S Key through the encryption unit 233 (S46), and provide the encrypted audio signal DataEnc to the antenna 120.

Thereafter, the secure communication device 200 may transmit the encrypted audio signal DataEnc and the sender public encryption key Pub_sr to the receiver 101 through the antenna 120.
the receiver 101 having received the encrypted audio signal DataEnc and the sender public encryption key Pub_sr from the sender 102 through the RF signal may generate a shared encryption key S Key by using the master public encryption key Pub_m shared during pairing and the sender public encryption key Pub_sr provided from the sender 102.

Thereafter, the receiver 101 may decrypt the encrypted audio signal DataEnc provided from the sender 102 by using the generated shared encryption key S Key.

Thereafter, the receiver 101 may output a decrypted audio signal through the audio output terminal 150.

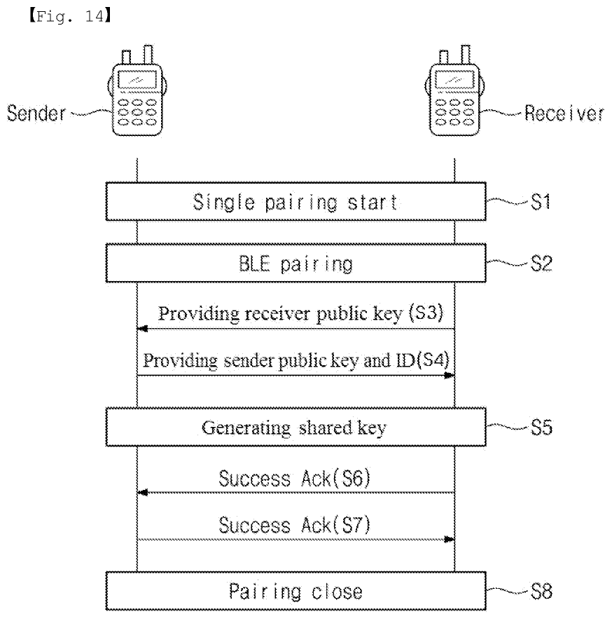

Hereinafter, a method of setting a pairing between secure communication devices according to a third embodiment of the present invention will be described with reference to FIG. 14.

The third embodiment of the present invention has a difference only in the pairing setting method and the encrypting scheme and has the same components compared with the first embodiment of the present invention, so detailed descriptions of the same components will be omitted.

Referring to FIG. 14, first, in a preliminary step to use the secure communication device as a radio transceiver, a pairing may start between the sender and at least one of the receivers (S1). To this end, Bluetooth Low Energy modules, for example, mounted in each of the sender and the receiver may be activated. Accordingly, the sender and the receiver may be paired through Bluetooth communication (S2).

During pairing, the receiver may provide the receiver public key to the sender (S3).

When trying to communicate with a specific receiver, the sender may provide a sender public key and an ID of the specific receiver to the receiver (S4). For example, the sender may add an ID_Mask Header assigned to the specific receiver and transmit the added ID_Mask Header to a data payload transmitted to the receiver. The sender may use the previously provided receiver public key, and encrypt and transmit the sender public key and the ID.

Accordingly, a plurality of receivers may check the ID first, and ignore the ID when the transmitted audio data packet is not configured to be transmitted to themselves.

Thereafter, the sender may generate a shared key by using the sender private key and the provided receiver public key, and the receiver may generate a shared key by using the receiver private key and the provided sender public key and use the shared key as an encryption key (S5).

Thereafter, when a feedback signal (Success ack) for transmission success is received from the receiver (S6), the sender may transmit a response signal (Success ack) to the receiver (S7).

After step S7 is completed, the sender and the specific receiver may maintain the pairing connection to enable audio communication (S8).

The specific receiver may be one receiver or a plurality of receivers forming the communication group with the sender.

When the sender is paired with one receiver, a whisper communication mode, that is, one-to-one audio communication, may be conducted.

In addition, when the sender is paired with multiple receivers, a group communication mode, that is, multilateral audio communication may be conducted.

As in the first embodiment, when the sender is designated as a master in the group communication mode, the master, for audio communication between the remaining slaves, may share the private keys provided from a plurality of slave with each of the slaves. In addition, when the sender is designated as a master in the group communication mode, the remaining slaves may use the master as a communication repeater to exchange audio signals with each other via the master.

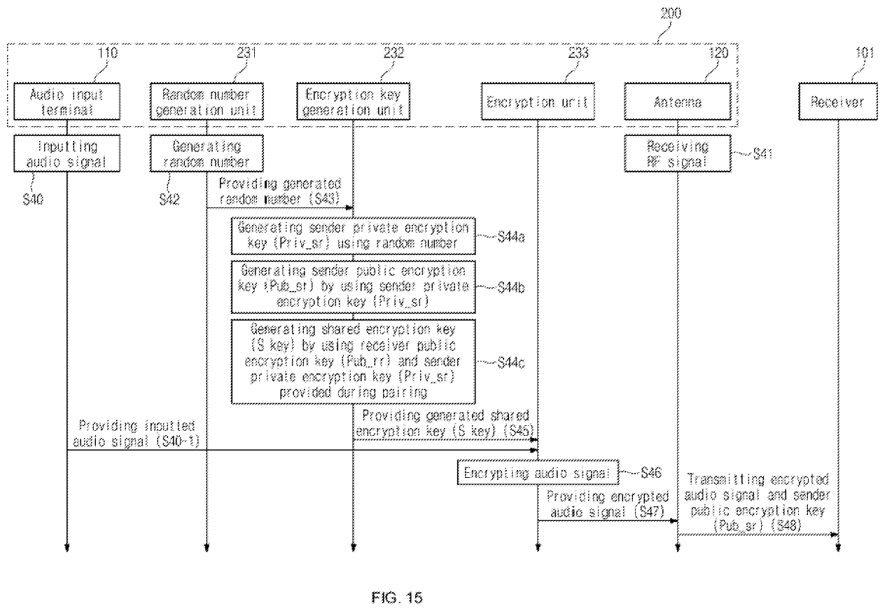

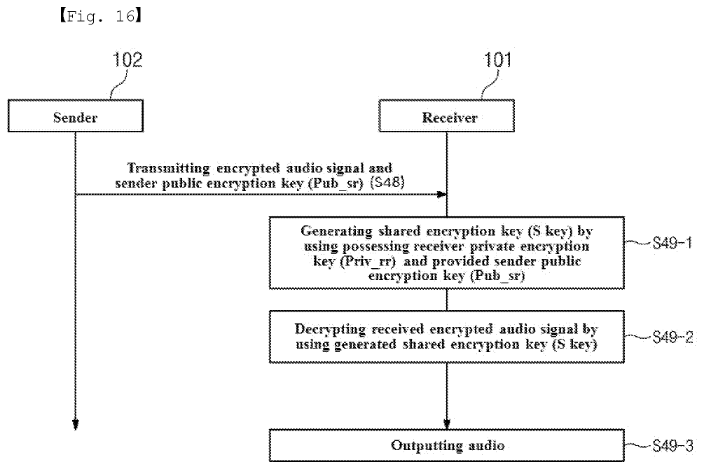

Hereinafter, a process of mutual audio communication between a plurality of secure communication devices in a paired state according to the third embodiment of the present invention will be described time-sequentially with reference to FIGS. 15 and 16.

Referring to FIG. 15, when an RF signal is received by the antenna 120 (S41), the secure communication device 200 may generate a new random number based on the RF signal, through the random number generation unit 231 whenever the RF signal is received (S42), and provide the generated random number to the encryption key generation unit 232 (S43).

Even when an audio signal is inputted to the audio input terminal 110 (S40), the secure communication device 200 may generate a new random number based on the audio signal, through the random number generation unit 231 whenever the audio signal is received (S42), and may provide the generated random number to the encryption key generation unit 232 (S43).

Thereafter, the secure communication device 200 may generate a sender private encryption key Priv_sr by using the random number, through the encryption key generation unit 232 (S44a).

In addition, the secure communication device 200 may generate a sender public encryption key Pub_sr by using the sender private encryption key Priv_sr, through the encryption key generation unit 232 (S44b).

Thereafter, the secure communication device 200 may generate a shared encryption key S Key by using the receiver public encryption key Pub_rr provided from the receiver 101 during pairing and the generated sender public encryption key Pub_sr, through the encryption key generation unit 232 (S44c).

As described above, since the random number is used as a seed signal of the shared encryption key S Key, a new random number is generated whenever the RF signal is received, and accordingly, the shared encryption key S Key may be refreshed.

Thereafter, the secure communication device 200 may provide the shared encryption key S Key generated through the encryption key generation unit 232 to the encryption unit 233 (S45).

Thereafter, the secure communication device 200 may provide the audio signal inputted to the audio input terminal 110 to the encryption unit 233 (S40-1), encrypt the audio signal by using the shared encryption key S Key through the encryption unit 233 (S46), and provide the encrypted audio signal DataEnc to the antenna 120 (S47).

Thereafter, the secure communication device 200 may transmit the encrypted audio signal DataEnc and the sender public encryption key Pub_sr to the receiver 101 through the antenna 120 (S48).

Next, referring to FIG. 16, the receiver 101 having received the encrypted audio signal DataEnc and the sender public encryption key Pub_sr from the sender 102 through the RF signal may generate a shared encryption key S Key by using the possessing receiver private encryption key Priv_rr and the sender public encryption key Pub_sr provided from the sender 102 (S49-1).

Thereafter, the receiver 101 may decrypt the encrypted audio signal DataEnc provided from the sender 102 by using the generated shared encryption key S Key (S49-2).

Thereafter, the receiver 101 may output a decrypted audio signal through the audio output terminal 150 (S49-3).

TABLE 1

| Definition | Sender | Receiver |
|---|---|---|
| First embodiment; | Pub_sr + Priv_rr* | Pub_sr + Priv_rr |
| Method of | | |
| generating S Key | | |
| Second embodiment; | Pub_sr + Master* | Pub_sr + Master* |
| Method of | | |
| generating S Key | | |
| Third embodiment; | Priv_sr + Pub_rr* | Pub_sr + Priv_rr |
| Method of | | |
| generating S Key | | |

Herein, ‘*’ is a previously possessing value

To summarize this, as shown in Table 1 above, in the first embodiment, the shared encryption key S Key of each of the sender and the receiver may be generated through the sender public encryption key Pub_sr and the receiver private encryption key Priv_rr.

In addition, in the second embodiment, the shared encryption key S Key of each of the sender and the receiver may be generated through the sender public encryption key Pub_sr and the master encryption key Master.

In addition, in the third embodiment, the shared encryption key S Key of the sender may be generated through the sender private encryption key Priv_sr and the receiver public encryption key Pub_rr, and the shared encryption key S Key of the receiver may be generated through the sender public encryption key Pub_sr and the receiver private encryption key Priv_rr.

The random number may be the same as the encryption key. According to the present invention, the encryption may be understood as a concept including encryption with a random number as well as encryption with an encryption key. In another aspect, the random number generation unit and the encryption key generation unit may have the same configuration.

Hereinafter, a pairing process and an encryption/decryption process thereby according to the fourth embodiment of the present invention will be described. The fourth embodiment may provide a more effective process of transferring a shared encryption key in multilateral communication such as 1:N and N:N (herein, the shared encryption key signifies an encryption key that encrypts an audio packet), and an encryption/decryption process thereby.

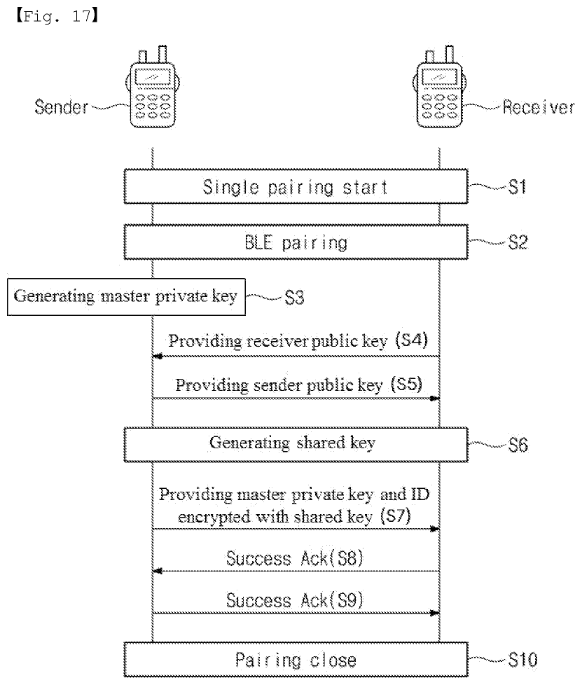

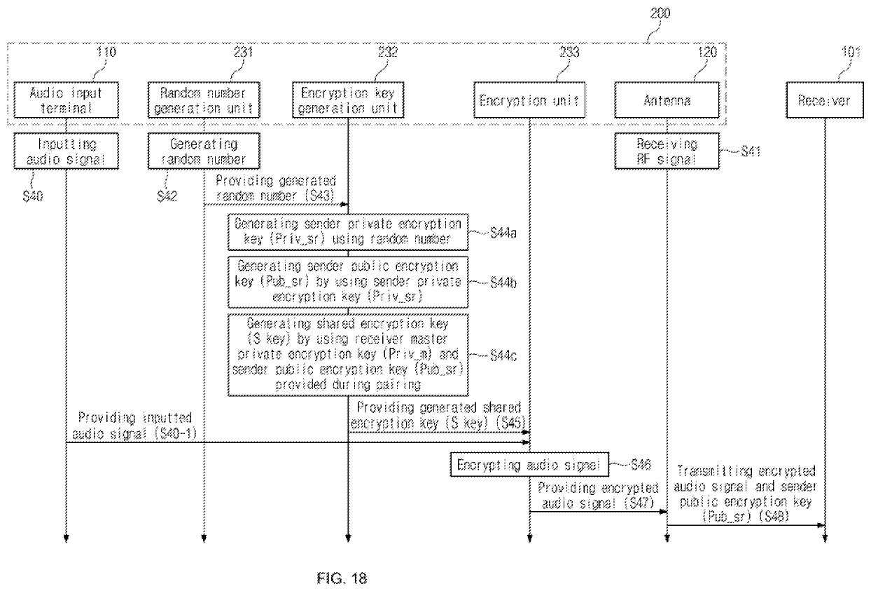

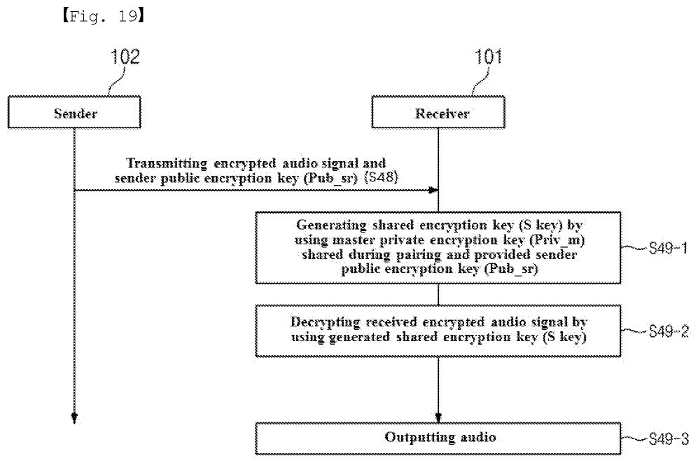

FIG. 17 is a flowchart for explaining a pairing process between secure communication devices according to the fourth embodiment of the present invention. FIG. 18 is a flowchart for time-sequentially explaining an encryption process of a control unit for the inputted audio signal in the secure communication device according to the fourth embodiment of the present invention. FIG. 19 is a flowchart for time-sequentially explaining a decryption process of the receiver for the encrypted audio signal in the secure communication device according to the fourth embodiment of the present invention.

In description of the fourth embodiment, duplicate descriptions of the first to third embodiments described above will be omitted.

Referring to FIG. 17, first, in a preliminary step to use the secure communication device as a radio transceiver, a pairing may start between the sender and at least one of the receivers (S1). The sensor is assumed as the master and the receiver is assumed as the slave. The master may perform a function of sharing a master private key necessary for encrypting audio data to at least one receiver. In another aspect, the same master private key may be used and encrypted/decrypted with respect to at least one receiver.

Bluetooth Low Energy modules, for example, mounted in each of the sender and the receiver may be activated. Accordingly, the sender and the receiver may be paired through Bluetooth communication (S2).

During pairing, the sender may generate a master private key (S3).

The sender may use at least one of a communication channel signal with the receiver, an ambient noise signal, its own signal, a ring oscillator, and a previously prepared lookup table so as to generate the master private key.

The sender and the receiver may share own public keys with each other (S4, S5).

The sender may first generate a sender private key, generate a sender public key based on the sender private key, and share the generated sender public key with the receiver.

The receiver may also generate a receiver private key first, generate a receiver public key based on the receiver private key, and share the generated receiver public key with the sensor.

Even in the above case, may use at least one of a communication channel signal, an ambient noise signal, its own signal, a ring oscillator, and a previously prepared lookup table to generate the private key of each of the sender and the receiver.

Each of the sender and the receiver may generate a shared encryption key used for encryption/decryption of the shared encryption key, respectively (S6).

More specifically, the sender may generate the shared encryption key based on the sender private key and the shared receiver public key, and the receiver may generate the same shared encryption key as the sender based on the receiver private key and the shared sender public key.

The sender may encrypt the master private key and a receiver ID identifiable for each receiver by using the generated shared encryption key and provide the master key and the receiver ID to the receiver (S7).

The receiver may decrypt the data provided from the sender in step S6 with the shared encryption key generated in step S5. Accordingly, the receiver may obtain the master private key and the receiver ID. When the master private key and the receiver ID are successfully obtained, the receiver may send ACK to the sender (S8) and the sender may send ACK to the receiver (S9), so that the pairing is successfully completed (S10).

When the above-described process is performed on at least one receiver, a master and at least one receiver in the same group may share the same master private key. Due to the relationship such as shared encryption key=f(sender private key, receiver shared key)=f(receiver private key, sender shared key) in step S5, the master private key may be transmitted and received more securely.

The description of the whisper mode based on the receiver ID will be omitted since it is the same as those in the previous embodiments.

In addition, upon describing each step with reference to FIG. 17, the precedence relationship of the steps shown in FIG. 17 may be modified with each other unless a temporal relationship is necessarily required.

Hereinafter, a process of mutual audio communication between a plurality of secure communication devices in a paired state according to the fourth embodiment of the present invention will be described time-sequentially with reference to FIGS. 18 and 19.

Referring to FIG. 18, when an RF signal is received by the antenna 120 (S41), the secure communication device 200 may generate a new random number based on the RF signal, through the random number generation unit 231 whenever the RF signal is received (S42), and may provide the generated random number to the encryption key generation unit 232 (S43).

Even when an audio signal is inputted to the audio input terminal 110 (S40), the secure communication device 200 may generate a new random number based on the audio signal, through the random number generation unit 231 whenever the audio signal is received (S42), and may provide the generated random number to the encryption key generation unit 232 (S43).

Thereafter, the secure communication device 200 may generate a sender private encryption key Priv_sr by using the random number, through the encryption key generation unit 232 (S44a).

In addition, the secure communication device 200 may generate a sender public encryption key Pub_sr by using the sender private encryption key Priv_sr, through the encryption key generation unit 232 (S44b).

Thereafter, the secure communication device 200 may generate a shared encryption key S Key by using the master private key Priv_m generated during pairing and the generated sender public encryption key Pub_sr, through the encryption key generation unit 232 (S44c).

For the reference, the shared encryption key of step S44 described with reference to FIG. 18 is an encryption key separate from the shared encryption key of step S5 described with reference to FIG. 17.

As described above, since the random number is used as a seed signal of the shared encryption key S Key, a new random number is generated whenever the RF signal is received, and accordingly, the shared encryption key S Key may be refreshed.

Thereafter, the secure communication device 200 may provide the shared encryption key S Key generated through the encryption key generation unit 232 to the encryption unit 233 (S45).

Thereafter, the secure communication device 200 may provide the audio signal inputted to the audio input terminal 110 to the encryption unit 233 (S40-1), encrypt the audio signal by using the shared encryption key S Key through the encryption unit 233 (S46), and provide the encrypted audio signal DataEnc to the antenna 120 (S47).

Thereafter, the secure communication device 200 may transmit the encrypted audio signal DataEnc and the sender public encryption key Pub_sr to the receiver 101 through the antenna 120 (S48).

Next, referring to FIG. 19, the receiver 101 having received the encrypted audio signal DataEnc and the sender public encryption key Pub_sr from the sender 102 through the RF signal may generate a shared encryption key S Key by using the master private encryption key Priv_m shared during pairing and the sender public encryption key Pub_sr provided from the sender 102 (S49-1).

Thereafter, the receiver 101 may decrypt the encrypted audio signal DataEnc provided from the sender 102 by using the generated shared encryption key S Key (S49-2).

Thereafter, the receiver 101 may output a decrypted audio signal through the audio output terminal 150 (S49-3).

According to the fourth embodiment described above with reference to FIGS. 17 to 19, the master private key may be safely transferred from a device serving as a master to a device serving as a slave, and thereafter, only the shared key of the sender is required to be delivered to the receiver without transmitting and receiving the master private key upon transmitting and receiving the audio data, so that the safety for security can be remarkably improved. Further, excellent security stability can be provided in that the shared key of the sender is constantly refreshed.

In addition, even in 1:N, N:N communication environments, the key used for audio signal security is the master private key shared during pairing, so that the number of using keys can be minimized, thereby reducing the communication load.

Meanwhile, according to the embodiments of the present invention, closed audio communication between specific secure communication devices 200 may be conducted among the paired secure communication devices 200.

The secure communication device 200 functioning as the sender 102 may further encrypt a MASK of an ID assigned to a specific receiver 101, through the encryption unit 233.

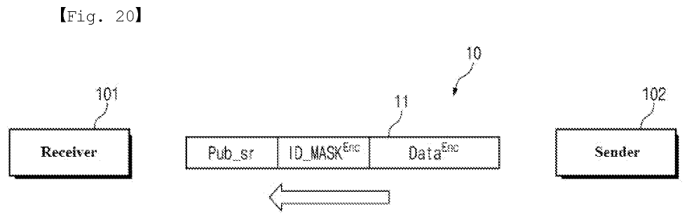

Referring to FIG. 20, thereafter, the secure communication device 200 may be transmit an audio data packet 10 composed of a payload 11 arranged in a sequence of the generated sender public encryption key Pub_sr, the encrypted ID MASK ID_MASKEnc, and the encrypted audio signal DataEnc, to the receiver 101, through the antenna 120.

Accordingly, before decrypting the encrypted audio signal DataEnc, the receiver 101 may check the encrypted ID MASK ID_MASKEnc and ignore the ID MASK when the transmitted audio data packet 10 is not configured to be transmitted to the receiver.

Accordingly, closed audio communication between specific secure communication devices 200 may be conducted.

In addition, according to the embodiments of the present invention, when the paired receiver 101 is provided with a plurality of receivers, and a plurality of groups including at least one receiver 101 among the receivers 101 are set, audio communication may be performed for each communication group.

The secure communication device 200 designated as the master M may generate a preamble in which a corresponding group ID is encrypted during pairing to distribute the preamble to the slaves S belonging to the same communication group. In another aspect, the preamble may be distributed to each of the receivers 101.

The secure communication device 200 functioning as the sender 102 may encrypt the group ID by using the sender public encryption key Pub_sr, through the encryption unit 233. Since the sender public encryption key Pub_sr is always changed, the preamble having the encrypted group ID also always has a different value.

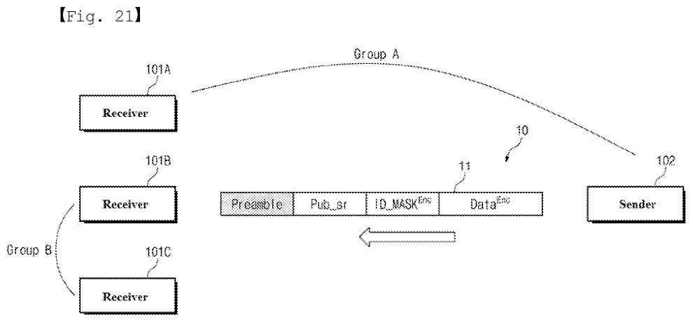

Referring to FIG. 21, in the secure communication device 200 the preamble having the encrypted corresponding group ID may be added to a front end of the payload 11 arranged in the sequence of the generated sender public encryption key Pub_sr, the encrypted ID MASK ID_MASKEnc, and the encrypted audio signal DataEnc.

In addition, the secure communication device 200 may transmit the audio data packet 10 composed of the payload 11 arranged in the sequence of the preamble, the sender public encryption key Pub_sr, the encrypted ID MASK ID_MASKEnc, and the encrypted audio signal DataEnc, to all groups including group A and group B, through the antenna 120.

Each of a receiver 101A belonging to the same group A as the sender 102, and receivers 101B and 101C belonging to group B different from the sender 102 may first check a value of the preamble by parsing the preamble, and ignore the transmitted audio data packet 10 when the ID does not correspond to the group to which each receiver belongs.

In addition, the receiver 101A belonging to the same group A as the sender 102 may check the value of the preamble, check the encrypted ID MASK ID_MASKEnc, and ignore the ID MASK when the transmitted audio data packet 10 is not configured to be transmitted to the receiver.

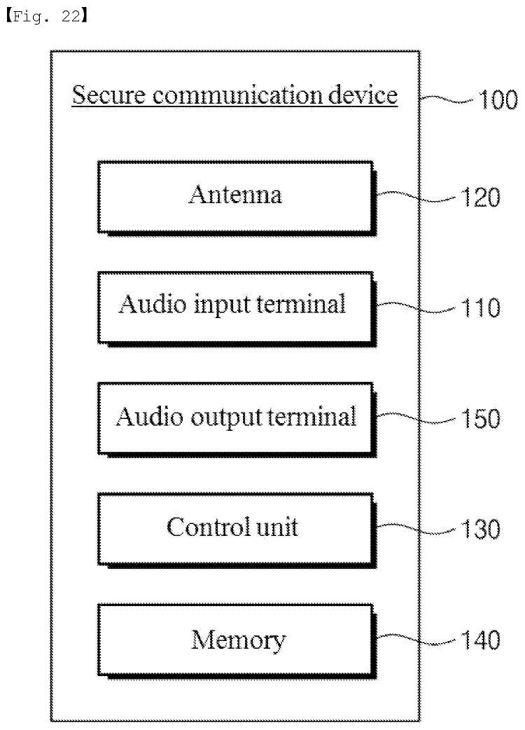

Hereinafter, a secure communication device according to the fifth embodiment of the present invention will be described with reference to FIGS. 22 to 24.

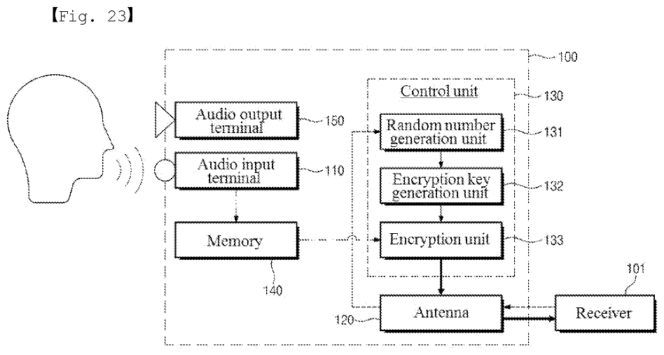

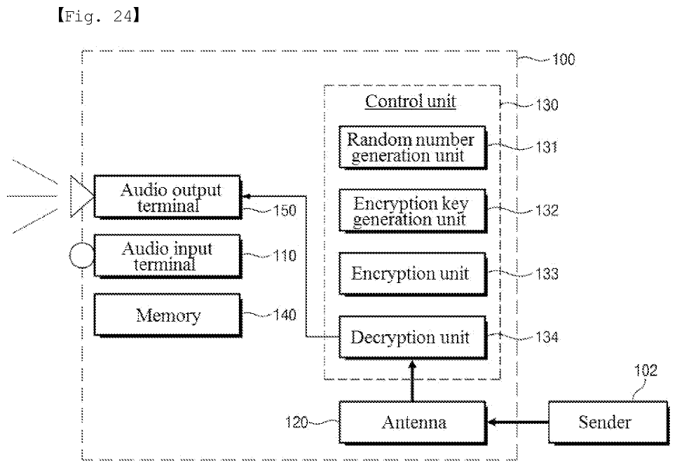

FIG. 22 is a block diagram schematically showing a secure communication device according to the fifth embodiment of the present invention. FIG. 23 is a block diagram for explaining a process in which an input audio signal is transmitted to a receiver in the secure communication device according to the fifth embodiment of the present invention. FIG. 24 is a block diagram for explaining a process in which an audio signal received from a sender is outputted in the secure communication device according to the fifth embodiment of the present invention.

Referring to FIG. 22, the secure communication device 100 according to the fifth embodiment of the present invention may include an audio input terminal 110, an antenna 120 and a control unit 130.

The audio input terminal 110, which serves as a device to which a user's audio signal is inputted, may be provided as, for example, a microphone. Correspondingly, the secure communication device 100 according to the fifth embodiment of the present invention may further include an audio output terminal 150. The audio output terminal 150, which serves as a device for outputting an audio signal received from another secure communication device 100, may be provided as, for example, a speaker.

The antenna 120 may receive an RF signal. The RF signal corresponds to a broad concept including electromagnetic waves applied from the outside, and may be understood as a concept including any one or both signals of a signal that includes information and a signal that does not include information.

The antenna 120 may receive the RF signal from a paired sender. In addition, the antenna 120 may receive RF signals generated from the paired slaves S1, S2, . . . , and Sn.

In other words, the antenna 120 may also receive RF signals generated between the slaves S1, S2, . . . , and Sn and corresponding to noise, in addition to the RF signal transmitted from a specific sender.

Meanwhile, when functioning as a sender, the antenna 120 may transmit the encrypted audio signal DataEnc generated by the control unit 130 to one or a plurality of slaves S1, S2, . . . , and Sn forming the same communication group serving as a receiver.

The memory 140 may store an audio signal. Specifically, the memory 140 may store an audio signal of the user inputted through the audio input terminal 110. Accordingly, the audio signal stored in the memory 140 may be encrypted by the control unit 130.

The control unit 130 may encrypt the audio signal inputted to the audio input terminal 110 based on the RF signal received by the antenna 120. The control unit 130 according to the fifth embodiment of the present invention may encrypt the audio signal through a symmetric key algorithm.

The control unit 130 having encrypted the audio signal may transmit the encrypted audio signal DataEnc to the paired one or multiple receivers 101 of FIG. 23, through the antenna 120.

In order to eliminate crosstalk with other receivers 101 in FIG. 23 having no approval for audio communication the control unit 130 may distribute the frequency to a receiver 101 in FIG. 23 approved for the audio communication through frequency hopping, and transmit an encrypted audio signal DataEnc to the receiver 101 of FIG. 23 by using the corresponding frequency band.

In addition, when the antenna 120 receives an RF signal from a paired sender 102 of FIG. 24, the control unit 130 may decrypt the encrypted audio signal DataEnc transmitted through the RF signal, and output a decrypted audio signal through the audio output terminal 150.

Referring to FIG. 23, the control unit 130 according to the fifth embodiment of the present invention may include a random number generation unit 131, an encryption key generation unit 132, and an encryption unit 133.

The random number generation unit 131 may generate a random number based on the RF signal received by the antenna 120. The random number generation unit 131 may generate a new random number based on the RF signal in order to encrypt the audio signal, whenever the RF signal is received by the antenna 120. The random number generation unit 131 may generate a random number by using disordered fluctuations in the intensity or sensitivity of the RF signal received in real time by the antenna 120.

The random number generation unit 131 may generate a random number based on an RF signal received from a specific receiver 101 among RF signals received by the antenna 120.

In addition, even when an RF signal corresponding to noise is received in viewpoint of the antenna 120, the random number generation unit 131 may generate a random number based on the RF signal.

According to one embodiment of the present invention, even the RF signal corresponding to the noise to the antenna 120 may be used by the random number generation unit 131 for generating the random number, so that the amount of random number generation and the speed of random number generation may be improved.

Accordingly, the random number generation unit 131 according to the fifth embodiment of the present invention may generate a physical random number based on the RF signal, or alternatively, may generate a random number by using an algorithmic manner. In addition, the random number generation unit 131 may also generate a random number by using a circuit manner such as a ring oscillator.

Hereinafter, it is assumed that the random number generation unit 131 generates a physical random number based on an RF signal.

The encryption key generation unit 132 may generate an encryption key by using the random number generated by the random number generation unit 131.

The encryption unit 133 may encrypt the audio signal stored in the memory 140 by using the encryption key generated by the encryption key generation unit 132.

Meanwhile, referring to FIG. 24, the control unit 130 may further include a decryption unit 134.

The decryption unit 134 may receive the encrypted audio signal DataEnc transmitted through the signal from the antenna 120 receiving the RF signal from the paired sender 102 and decrypt the received audio signal.

Accordingly, the audio signal decrypted by the decryption unit 134 may be outputted to the outside by the audio output terminal 150 provided as a speaker.

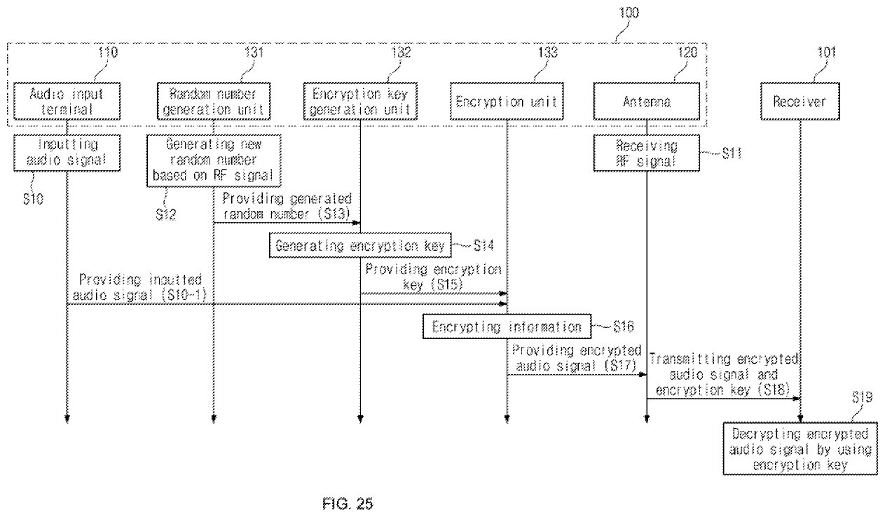

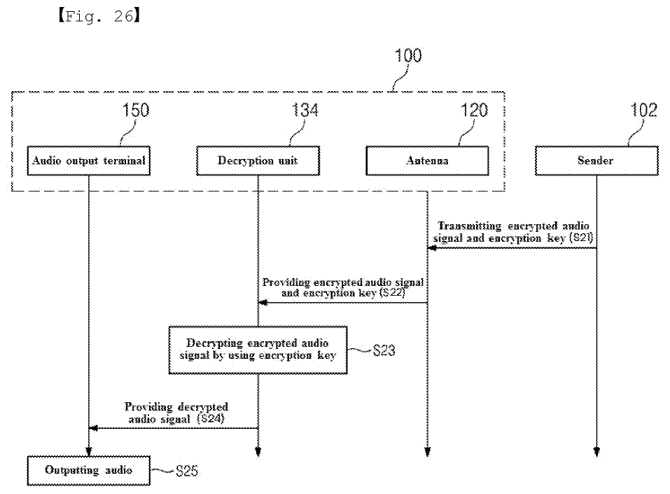

Hereinafter, a process of mutual audio communication between a plurality of secure communication devices in a paired state according to one embodiment of the present invention will be described time-sequentially with reference to FIGS. 25 and 26.

Referring to FIG. 25, when an RF signal is received by the antenna 120 (S11), the secure communication device 100 may generate a new random number based on the RF signal, through the random number generation unit 131 whenever the RF signal is received (S12), and provide the generated random number to the encryption key generation unit 132 (S13).

Even when an audio signal is inputted to the audio input terminal 110 (S10), the secure communication device 100 may generate a new random number based on the audio signal, through the random number generation unit 131 whenever the audio signal is received (S12), and may provide the generated random number to the encryption key generation unit 132 (S13).

Thereafter, the secure communication device 100 may generate an encryption key by using a random number through the encryption key generation unit 132 (S14), and may provide the generated encryption key to the encryption unit 133 (S15).

Thereafter, the secure communication device 100 may provide the audio signal inputted to the audio input terminal 110 to the encryption unit 133 (S10-1), encrypt the audio signal with the encryption key through the encryption unit 133 (S16), and transmit the encrypted audio signal DataEnc and the encryption key to the receiver 101 through the antenna 120 (S17 and S18).

Accordingly, the receiver 101 may decrypt and output the encrypted audio signal DataEnc by using the encryption key transmitted from the secure communication device 100 functioning as the sender (S19).

Meanwhile, referring to FIG. 26, when the secure communication device 100 functions as a receiver, and when the encrypted audio signal DataEnc and the encryption key transmitted through the RF signal from the sender 102 are received by the antenna 120 (S21), the secure communication device 100 may provide the encrypted audio signal DataEnc and the encryption key received by the antenna 120 to the decryption unit 134, decrypt the encrypted audio signal DataEnc through the decryption unit 134 by using the provided encryption key (S22 and S23).

Thereafter, the secure communication device 100 may provide the decrypted audio signal to the audio output terminal 150 (S24), and may output an audio through the audio output terminal 150 (S25).

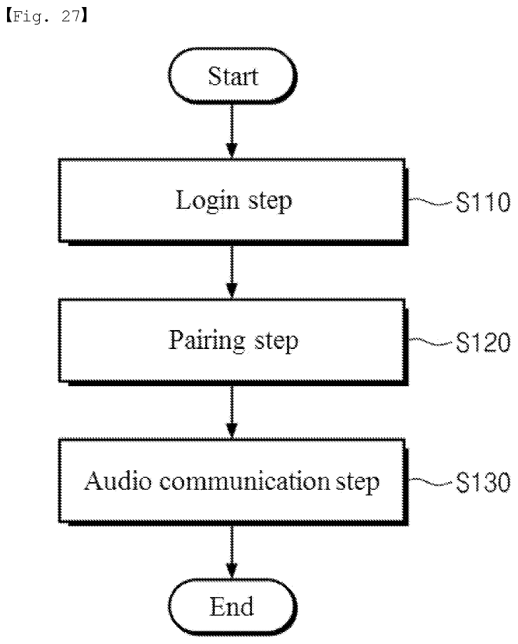

Hereinafter, a secure communication program according to one embodiment of the present invention will be described with reference to FIG. 27. Reference numerals of components refer to FIGS. 22 to 24.

Referring to FIG. 27, the secure communication program according to one embodiment of the present invention may be stored in a medium to execute login step S110, pairing step S120 and audio communication step S130.

First, the secure communication program according to one embodiment of the present invention may execute login step S110 in which a login module is activated to enable a user having downloaded and installed a dedicated app provided from a server to log in.

The user may be a member who has provided private information such as sex, age, contact information, and address to the server. However, the user is not limited thereto and may be a temporary member or a non-member. In other words, the secure communication program according to one embodiment of the present invention may be provided as an open type program that anyone is permitted to use.

Thereafter, the secure communication program may execute pairing step S120 in which a pairing module is activated such that the user may pair the secure communication device 100 of the user with at least one receiver 101.

In pairing step S120, the secure communication device 100 of the user may be paired with another's secure communication device 100, that is, the receiver 101, through analog communication or digital communication such as Bluetooth Low Energy and CDMA.

In pairing step S120, an interface for setting the user to form a communication group with at least one receiver 101 may be provided.

In pairing step S120, in order to generate a shared encryption key S Key, a master encryption key may be generated and shared with the receivers 101, or a receiver private encryption key Priv_rr or a receiver public encryption key Pub_rr may be provided from the receivers 101.

Thereafter, the secure communication program may execute audio communication step S130 in which an audio communication module is activated, such that the user may communicate with at least one receiver 101 paired while using an audio signal.

In audio communication step S130, when the user inputs an audio signal through the audio input terminal 110, the audio signal may be encrypted through the above-mentioned symmetric key algorithm or asymmetric key algorithm based on the received RF signal, and an audio data packet 10 including the encrypted audio signal DataEnc may be transmitted to the receiver 101.

In audio communication step S130, when the user requests audio communication with a specific receiver 101, a MASK of an ID assigned to the specific receiver 101 may be encrypted, included in the audio data packet 10, and transmitted to a plurality of paired receivers 101.

In the above case, before decrypting the encrypted audio signal DataEnc, the receivers 101 may check the encrypted ID MASK ID_MASKEnc and ignore the ID MASK when the transmitted audio data packet 10 is not configured to be transmitted to the receiver.

Accordingly, the user can perform audio communication with a counterpart using the specific receiver 101 desired by the user.

In addition, in audio communication step S130, when the user requests audio communication with a communication group set up by the user, a preamble having an encrypt ID of the corresponding communication group may be added to a front end of a payload 11 constituting the audio data packet 10 so as to be transmitted to the paired receivers 101.

In the above case, the receiver 101 for each communication group may first check a value of the preamble by parsing the preamble, and ignore the transmitted audio data packet 10 when the ID does not correspond to the group to which each receiver belongs.

Accordingly, the user can perform one-to-one or multilateral audio communication with the communication group to which the user belongs in an environment in which security is maintained.

The preamble may be generated in pairing step S120 and distributed to the receivers 101 belonging to the same communication group.

Meanwhile, in audio communication step S130, when the encrypted audio signal DataEnc is received through the RF signal from the sender 102, the received encrypted audio signal may be decrypted, and the decrypted audio signal may be outputted through the audio output terminal 150 so as to allow the user to listen to the outputted audio signal.

The secure communication program according to one embodiment of the present invention may execute any step corresponding to the technical idea the present invention. For example, the secure communication program according to one embodiment of the present invention may perform the secure communication according to the first to fifth embodiments and modifications thereof, and perform the ID mask function described with reference to FIG. 20 and the group ID filtering function described with reference to FIG. 21.

In one embodiment of the present invention, the secure communication device 100 may be, for example, a smartphone, and the secure communication program may be stored on the smartphone, and implemented in the form of an application to execute the above steps.

The secure communication program according to one embodiment of the present invention may be applied and driven in any electronic device that can be paired. For example, the secure communication program according to an embodiment may be applied and driven on a smart phone.

In addition, when the embodiments of the present invention are described, the audio signal has been assumed as a target to be encrypted, however, this is merely an example, and the target to be encrypted may be variously applied. For example, the encrypted data may be image data, health-related data, private information data, or the like, but is not limited thereto.

While the inventive concepts have been described with reference to exemplary embodiments, it will be apparent to those skilled in the art that various changes and modifications may be made without departing from the spirits and scopes of the inventive concepts. Therefore, it should be understood that the above embodiments are not limiting, but illustrative. Thus, the scopes of the inventive concepts are to be determined by the broadest permissible interpretation of the following claims and their equivalents, and shall not be restricted or limited by the foregoing description.

What is claimed is:

1. A secure communication device comprising:
an audio input terminal for receiving an audio signal;
an antenna;
a pairing unit providing a master encryption key shared with at least one receiver upon pairing with the at least one receiver;
an encryption key generation unit for generating a sender encryption key and generating a shared encryption key by using the generated sender encryption key and a master encryption key shared during the pairing; and
a control unit including a transmitter configured to, when transmitting the audio signal to a specific receiver, transmit an audio data packet composed of the sender encryption key, a receiver ID for identifying a reception of a specific receiver encrypted with the sender encryption key, and the audio signal encrypted by the shared encryption key through the antenna.

2. The secure communication device of claim 1, wherein the control unit transmits the encrypted audio signal to one receiver or a plurality of receivers.

3. The secure communication device of claim 1, further comprising:
an audio output terminal, wherein,
when the antenna receives an RF signal from a paired sender, the control unit decrypts the encrypted audio signal transmitted through the RF signal to output the decrypted audio signal through the audio output terminal.

4. The secure communication device of claim 1, further comprising:
a memory for storing the audio signal, wherein
the memory further stores the master encryption key,
the sender encryption key includes a sender private encryption key (Priv_sr), and
the control unit further includes
a random number generation unit for newly generating a random number based on the RF signal to encrypt the audio signal whenever the antenna receives the RF signal; and
an encryption unit for encrypting the audio signal stored in the memory by using the generated shared encryption key (S Key), wherein
the encryption key generating unit generates a sender private encryption key (Priv_sr) by using the random number generated by the random number generation unit, and generates a sender public encryption key (Pub_sr) based on the sender private encryption key (Priv_sr), so as to generate the shared encryption key (S Key) by using any one of the sender private encryption key (Priv_sr) and the sender public encryption key (Pub_sr) and the master encryption key, and wherein
the control unit, when receiving the RF signal, generates the random number through the random number generation unit,
generates the sender private encryption key (Priv_sr), the sender public encryption key (Pub_sr) and the shared encryption key (S Key) through the encryption key generation unit,
encrypts the audio signal using the shared encryption key (S Key) through the encryption unit, and
transmits the encrypted audio signal (DataEnc) and the generated sender public encryption key (Pub_sr) to the receiver through the antenna.

5. The secure communication device of claim 4, wherein the master encryption key is any one of a master private encryption key (Priv_m) and a master public encryption key (Pub_m).

6. The secure communication device of claim 1, wherein the receiver decrypts the encrypted audio signal by using the master encryption key provided during the pairing and the transmitted sender encryption key.

7. The secure communication device of claim 1, wherein the encryption key generation unit refreshes the sender encryption key by using a random number newly generated according to the RF signal received by the antenna.

8. A secure communication program stored in a computer-readable recording medium to execute:
a login step of executing a login module to enable a user having downloaded and installed a dedicated app provided from a server to log in;
a pairing step of executing a pairing module to enable the user to pair the secure communication device according to claim 1 with at least one receiver; and
an audio communication step of executing an audio communication module to enable the user to communicate with the paired at least one receiver by using an audio signal, wherein,
in the pairing step, the pairing module is executed to provide a shared master encryption key to the at least one receiver so as to further execute an encryption key generation step in which an encryption key generation module is executed to generate a sender encryption key and generate a shared encryption key by using the generated sender encryption key and the master encryption key shared during the pairing, and
in the audio communication step, when transmitting the audio signal to a specific receiver, the audio communication module is executed to transmit, an audio data packet composed of the sender encryption key, the receiver ID for identifying reception of the specific receiver encrypted with the sender encryption key, and the audio signal encrypted with the shared encryption key, to the at least one receiver.

9. A secure communication device comprising:
a memory for storing data to be transmitted to at least one external electronic device, and a fixed master key;
an antenna for communicating with the at least one external electronic device; and
a control unit configured to generate a refresh key and encrypt the data stored in the memory by generating a shared encryption key based on the refresh key and the fixed master key to transmit encrypted data, the refresh key, and an electronic device ID identifying reception of a specific external electronic device encrypted with the refresh key to the at least one external electronic device through the antenna, wherein
the master key is already stored in the memory prior to the transmission.
